(19) United States
(12) Patent Application Publication
(10) Pub. No.: US 2009/0231330 A1
(43) Pub. Date: Sep. 17, 2009

(54) Method and system for rendering a three-dimensional scene using a dynamic graphics platform

(75) Inventor: Jackson Dunstan, Burbank, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/075,493

(22) Filed: Mar. 11, 2008

(51) Int. Cl. G06T 15/00

(52) U.S. Cl. 345/419

(57) ABSTRACT

There is provided a method of rendering a three-dimensional (3D) scene for viewing on a display using a dynamic graphics platform, where the scene is represented by first group of polygons in 3D space. The method includes determining second and third groups of polygons from first group of polygons, where second group of polygons is determined to be substantially entirely visible in the scene at a viewpoint and third group of polygons is determined to be partially visible in the scene at the viewpoint, projecting vertices of the second and third groups of polygons for viewing on the display, removing portion of each of the third group of polygons determined to be not visible when viewed on the display to form fourth group of polygons, which includes the second group of polygons, and preparing each of the fourth group of polygons for drawing in a pixel-by-pixel process on the display.

### BACKGROUND OF THE INVENTION

1. Field of the Invention

The present invention relates generally to the production of dynamic graphical content. More particularly, the present invention relates to rendering three-dimensional (3D) dynamic graphical content.

2. Related Art

Dynamic graphical content can be added to web pages by using dynamic graphical platforms, such as the Adobe Flash (hereinafter referred to simply as “Flash”) platform, which is a set of multimedia technologies that are developed and distributed by Adobe Systems, Inc. For example, the Flash platform can be used to add interactivity and animation to web pages and to create rich Internet applications or games. Web content created by the Flash platform can be viewed on a display, such as a computer monitor, by using Adobe Flash Player, which can be obtained from Adobe Systems at no charge. As the Flash platform continues to advance through succeeding versions, the computational speed provided by the Flash platform has greatly improved. However, three-dimensional (3D) rendering, which has been commonly available on personal computers and video game consoles for years, has been unavailable to Flash-based applications, since the Flash platform lacks a 3D rendering component.

Although the standard 3D pipeline is well-known in the art and has been available for a long time, many of the techniques used in standard 3D rendering are too slow to use in the Flash platform. For example, the standard 3D rendering pipeline uses vertex and polygon buffers, such as triangle buffers, which store data sequentially. The vertex buffer stores all of the vertices, i.e., points in 3D space, for every object to be drawn onto a display. In a triangle buffer references to the vertex buffer can be stored in groups of three, thereby defining the triangles that represent the 3D objects to be drawn on the display. The standard 3D pipeline can transform the vertices in the vertex buffer from the 3D space to a two-dimensional (2D) space, and then draws the triangles on the display by referencing the three transformed vertices. In Flash platform, however, array access and storage is extremely slow. As a result, continually accessing the vertex buffer through the triangle buffer's references to the vertex buffer causes significant performance degradation in rendering non-trivial 3D scenes.

In one conventional approach to Flash-based 3D rendering, 3D rendering is accomplished on a per-triangle level by utilizing the Flash platform's ability to quickly draw an entire triangle. However, drawing triangles in their entirety can cause various problems. Consider, for example, the situation in which two triangles intersect in an “X” pattern. In this approach, one of the two triangles is drawn in its entirety and then the other triangle is drawn in its entirety directly on top of the first triangle. As a result, the portion of the bottom triangle that intersects the top triangle is covered up by the top triangle, thereby incorrectly rendering the intersecting triangles.

According, there is a need in the art to overcome the drawbacks and deficiencies of existing 3D rendering approaches by providing a method and system for achieving fast and accurate rendering of 3D scenes using a dynamic graphics platform, such as the Flash platform.

### SUMMARY OF THE INVENTION

There are provided methods and systems for rendering a three-dimensional scene using a dynamic graphics platform, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for implementing a three-dimensional rendering application, according to one embodiment of the present invention;

FIG. 2 is a flowchart presenting a method of rendering a three-dimensional scene on a display using a dynamic graphics platform, according to one embodiment of the present invention;

FIG. 3 shows a diagram of a scene including two intersecting triangles as rendered by an exemplary conventional 3D rendering application; and

FIG. 4 shows a diagram of a scene including two intersecting triangles as rendered by an exemplary 3D rendering application, according to one embodiment of the present invention.

### DETAILED DESCRIPTION OF THE INVENTION

The present application is directed to a method and system for rendering three-dimensional scene using a dynamic graphics platform. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

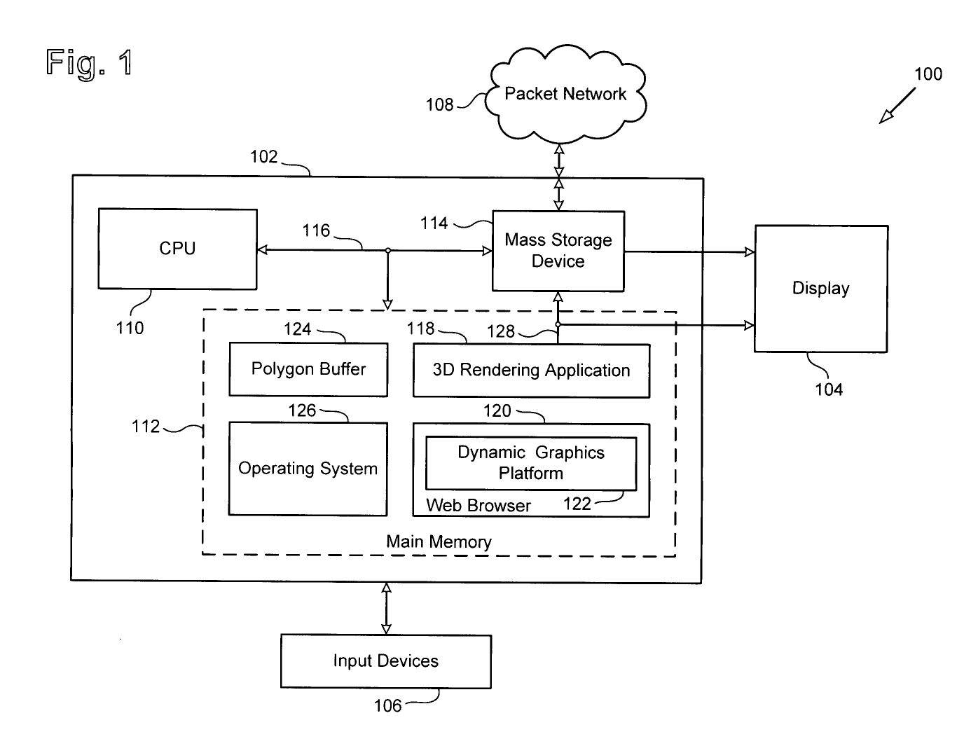

FIG. 1 shows a diagram of system 100 for implementing a 3D rendering application, according to one embodiment of the present invention. In the embodiment of FIG. 1, system 100 includes computer 102, display 104, input devices 106, and packet network 108. Computer 102 includes a controller or central processing unit (CPU) 110, main memory 112, mass storage device 114, and bus 116. Computer 102 can also include read only memory (ROM), an input/output (I/O) adapter, a user interface adapter, a communications adapter, and a display adapter, which are not shown in FIG. 1. Computer 102 can further include a compact disk (CD), a digital video disk (DVD), and a flash memory storage device, which are also not shown in FIG. 1, as well as other computer-readable media as known in the art. Computer 102 can be, for example, a personal computer (PC) or a work station. However, it is understood and appreciated by those skilled in the art that the method of rendering a 3D scene for viewing on a display by using, for example, a Flash platform, may also be implemented using a variety of different computer arrangements other than those specifically mentioned herein.

As shown in FIG. 1, CPU 110 is coupled to mass storage device 114 and main memory 112 via bus 116, which provides a communications conduit for the above devices. CPU 110 can be a microprocessor, such as a microprocessor manufactured by Advanced Micro Devices, Inc., or Intel Corporation. Mass storage device 114 can provide storage for data and applications and can comprise a hard drive or other suitable non-volatile memory device. Main memory 112 provides temporary storage for data and applications and can comprise random access memory (RAM), such as dynamic RAM (DRAM), or other suitable type of volatile memory. Also shown in FIG. 1, main memory 112 includes 3D rendering application 118, web browser 120, dynamic graphics platform 122, such as a Flash platform, polygon buffer 124, which can be, for example, a triangle buffer, and operating system 126, which can be, for example, a Microsoft Windows or Macintosh operating system. Web browser 120 can include dynamic graphics platform 122 as a plug-in and can be Microsoft's Internet Explorer, Mozilla Foundation's Firefox, or any other suitable web browser.

It should be noted that 3D rendering application 118, web browser 120, and dynamic graphics platform 122 are shown to reside in main memory 112 to represent the fact that programs are typically loaded from slower mass storage, such as mass storage device 114, into faster main memory, such as DRAM, for execution. However, 3D rendering application 118, web browser 120, polygon buffer 124, and operating system 126 can also reside in mass storage device 114 or other suitable computer-readable medium not shown in FIG. 1.

Further shown in FIG. 1, output 128 of 3D rendering application 118 is coupled to mass storage device 114 and display 104, mass storage device 114 and computer 102 are coupled to packet network 108, and mass storage device 114 is coupled to display 104. Display 104 provides a screen for viewing output 128 of 3D rendering application 118, which can provide a 3D scene that has been rendered in 3D. Output 128 of 3D rendering application can also be stored on mass storage device 114 and viewed on display 104 via mass storage device 114. Output 128 of 3D rendering application 118 can also be transmitted from mass storage device 114 over packet network 108 for a user to display or store on, for example, the user's hard disk. Packet network 108 can include, for example, the Internet, which can be accessed by web browser 120. Also shown in FIG. 1, input devices 106 are coupled to computer 102 to permit a user to communicate with and control the computer. Input devices 106 can include, for example, a keyboard and/or a mouse or other suitable input devices.

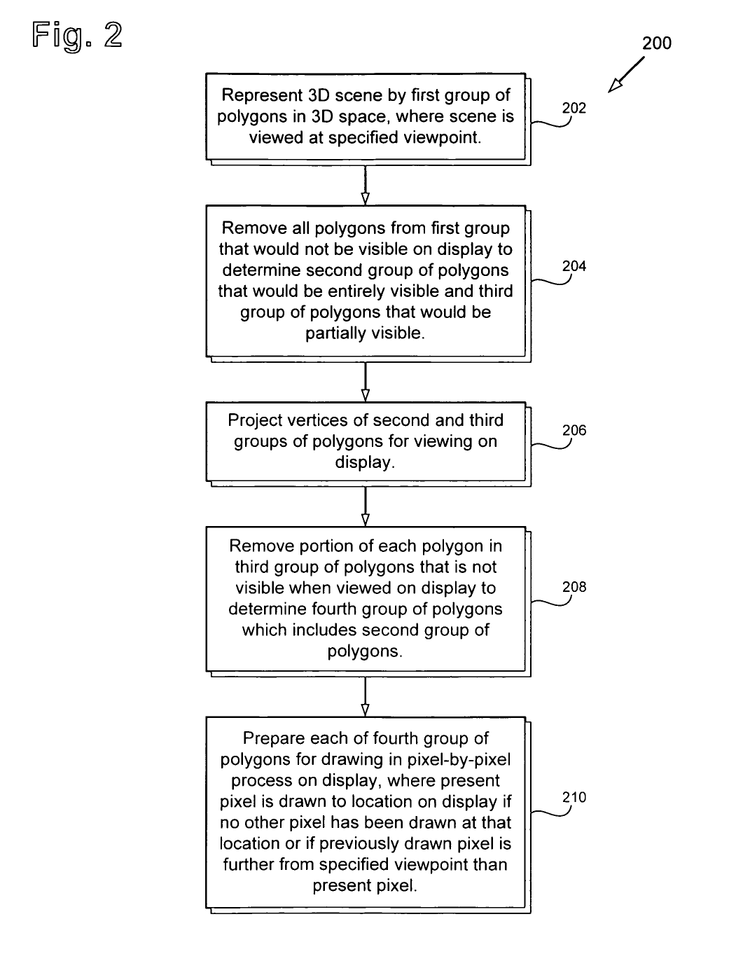

CPU 110 of computer 102 can be configured to run 3D rendering application 118 to correctly and quickly render a 3D scene for viewing on a display, such as display 104, using dynamic graphics platform 122, such as a Flash platform. A method of rendering a 3D scene for viewing on a display, such as display 104, using the Flash platform will be discussed below in flowchart 200 in FIG. 2.

FIG. 2 shows flowchart 200 illustrating a method for rendering a 3D scene for viewing on a display using an embodiment of the rendering application and a dynamic graphics platform, such as the Flash platform, in accordance with one embodiment of the present invention. Certain details and features have been left out of flowchart 200 that are apparent to a person of ordinary skill in the art. For example, a step may consist of one or more substeps or may involve specialized equipment or materials, as known in the art. While steps 202 through 210, in FIG. 2, are sufficient to describe a particular embodiment of the present method, other embodiments may utilize steps different from those shown in flowchart 200, or may include more or fewer steps. Further, one of ordinary skill in the art understands that CPU 110 in computer 102 can be configured to perform one or more steps 202 through 210 of flowchart 200, or any of the steps 202 through 210 can be performed by a special-purpose hardware.

In one embodiment, 3D rendering application 118 can be executed in a dynamic graphics platform, such as the Flash platform, which does not provide support for 3D rendering. 3D rendering application 118 can be executed on the Flash platform, 3D rendering application 118 can transform the vertices of polygons, such as triangles, representing a 3D scene from a 3D space into a 2D space and can fill the polygons in a pixel-by-pixel process to correctly render the 3D scene for viewing on a display, such as a computer monitor.

Referring now to step 202 in FIG. 2, at step 202 of flowchart 200, a 3D scene is represented by a first group of polygons, such as triangles, in a 3D space, where the scene is viewed from a given viewpoint. The “viewpoint” refers to a point in the 3D scene from which the scene is viewed by a virtual camera. A list of the polygons, such as triangles, that represent the scene can reside in a polygon buffer, such as polygon buffer 124 in FIG. 1. In contrast to a standard 3D pipeline, the polygon buffer used by the present embodiment includes the actual vertices of the polygons, such as triangles, representing the 3D scene. At step 204 of flowchart 200, all of the polygons in the first group of polygons that would not be visible on a display are removed from the first group of polygons to determine a second group of polygons that would be substantially entirely visible on the display and a third group of polygons that would be partially visible on the display. For example, polygons, such as triangles, situated behind the virtual camera from which the scene is viewed would not be visible in the 3D scene. The polygons that would not be visible on the display can be removed using, for example, a culling process.

At step 206 of flowchart 200, the vertices of the second and third groups of polygons, such as triangles, are projected for viewing on the display, such as display 104 in system 100 in FIG. 1. In particular, the vertices of the second and third groups of polygons are transformed from 3D space to 2D space for projection onto the display. At step 208 of flowchart 200, a portion of each polygon in the third group of polygons that is not visible when viewed on the display is remove to determine a fourth group of polygons, which includes the second group of polygons. For example, each of the polygons in the third group of polygons, which includes polygons that are only partially visible when viewed on the display, can be broken into smaller polygons. For example, if one polygon in the third group of polygons straddles the side of the display, the portion of the polygon that would not be visible on the display can be removed or chopped off in a clipping process. After the portions of polygons in the third group that would not be seen on the display have been removed, the remaining polygons from the third group of polygons are combined with the second group of polygons to form a fourth group of polygons.

At step 210 of flowchart 200, each of the polygons in the fourth group of polygons is prepared for drawing in a pixel-by-pixel process on the display. In the pixel-by-pixel process, a present pixel, i.e., a pixel that has been selected to be drawn, is drawn to a location on the display if either no other pixel has been drawn at that location or if a pixel has been drawn at that location, but the previously drawn pixel is further from the viewpoint, i.e., the point from which a virtual camera views the scene, than the present pixel. Thus, a present pixel is drawn to a location on the display if no other pixel has been drawn at that location. However, if a pixel has already been drawn at contemplated location, the present pixel is tested to determine if the present pixel is closer to the point at which a virtual camera views the scene (i.e. the viewpoint) compared to the previously drawn pixel. If the present pixel is closer to the viewpoint, which indicates that the previously drawn pixel would be obscured by the present pixel in the scene, the present pixel is drawn over the previously drawn pixel. If the present pixel is further from the viewpoint, which indicates that the present pixel would be obscured in the scene by the previously drawn pixel, the present pixel is not drawn over the previously drawn pixel.

Each of the fourth group of polygons that has been prepared for drawing in the pixel-by-pixel process can be displayed or viewed by drawing each of the fourth group of polygons on a display, such as display 104, in the pixel-by-pixel process. Each of the fourth group of polygons that has been prepared for drawing in the pixel-by-pixel process on the display can also be stored in mass storage device 114 or transmitted over packet network 108 for display by a user or for storage on a server or a user's hard disk.

Thus, for example, by drawing each polygon of a group of polygons representing a 3D scene in a pixel-by-pixel process as discussed above, the present embodiment achieves a correct rendering of a 3D scene using, for example, a Flash platform. Also, in contrast to a standard 3D rendering pipeline, the polygon buffer used by the present embodiment contains actual vertices of the polygons, such as triangles, that represent the 3D scene rather than only references to a vertex buffer, which is not required by the present embodiment. As a result, the present embodiment avoids having to perform multiple vertex buffer accesses per polygon, thereby achieving a significant increase in rendering speed in the Flash platform.

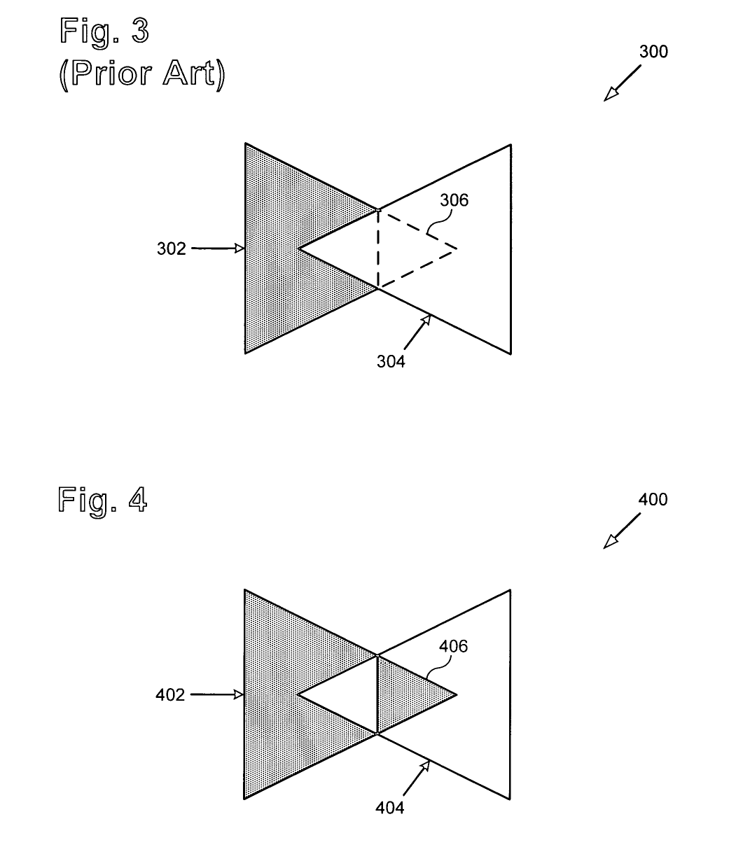

FIG. 3 shows a diagram of scene 300 including two intersecting triangles as rendered by a conventional 3D rendering application. In the conventional 3D rendering application, each triangle in a scene is drawn in its entirety before another triangle is drawn. Thus, in scene 300 in FIG. 3, triangle 302 is drawn in its entirety and then triangle 304 is drawn in its entirety on top of triangle 302. Since triangle 302 intersects triangle 304 and vice versa, portion 306 of triangle 302 should be visible. However, since triangle 304 is drawn in its entirety on top of triangle 302, portion 306 of triangle 302 is obscured by triangle 304. Thus, the process of drawing each triangle in a scene in its entirety, as used in the conventional 3D rendering application, can result in an incorrectly rendered scene.

FIG. 4 shows a diagram of scene 400 including two intersecting triangles as rendered by a 3D rendering application, according to one embodiment of the present invention. In the 3D rendering application of the present embodiment, the triangles representing a scene are drawn in a pixel-by-pixel process, where a present pixel is tested to determine if it will obscure a pixel previously drawn at the intended location of the present pixel. The present pixel is only drawn at the intended location if another pixel has not been drawn at that location or if a previously drawn pixel is further from a viewpoint (i.e. a point from which the scene is viewed by a virtual camera in the scene) compared to the present pixel.

In FIG. 4, scene 400 includes intersecting triangles 402 and 404. In the 3D rendering application, either triangle 402 or triangle 404 may be drawn first in a pixel-by-pixel process. If triangle 402 is drawn first, when triangle 404 is drawn, portion of triangle 404 that obscures portion 406 of triangle 402 are not drawn, since each pixel in portion 406 of triangle 402 is closer to the viewpoint compared to a corresponding overlapping pixel in triangle 404. A similar result is achieved if triangle 404 is drawn before triangle 402. Thus, by drawing each of triangles 402 and 404 in a pixel-by-pixel process, and appropriately testing each pixel before it is drawn at an intended location on the display, the 3D rendering application can correctly render the intersecting triangles in scene 400.

Thus, by utilizing a pixel-by-pixel process to draw each polygon of a group of polygons that represent a 3D scene, and drawing each pixel at an intended location on a display only if either no other pixel has been drawn at that location or if a previously drawn pixel the intended location is further from a viewpoint of the scene than the present pixel, the 3D rendering application can correctly render a scene in 3D using a dynamic graphics platform, such as a Flash platform. Also, by utilizing a polygon buffer containing actual vertices of the polygons, such as triangles, representing a 3D scene rather than simple references to a vertex buffer, the 3D rendering application advantageously achieves a significant increase in rendering speed in the Flash platform compared to the approach used by a standard 3D rendering pipeline.

From the above description of the invention it is manifest that various techniques can be used for implementing the concepts of the present invention without departing from its scope. Moreover, while the present invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method of rendering a three-dimensional (3D) scene for viewing on a display using a dynamic graphics platform, the scene being represented by a first plurality of polygons in a 3D space, the method comprising:
determining second and third pluralities of polygons from the first plurality of polygons, the second plurality of polygons determined to be substantially entirely visible in the scene at a viewpoint and the third plurality of polygons determined to be partially visible in the scene at the viewpoint;
projecting vertices of the second and third pluralities of polygons for viewing on the display;
removing a portion of each of the third plurality of polygons determined to be not visible when viewed on the display to form a fourth plurality of polygons, the fourth plurality of polygons including the second plurality of polygons; and
preparing each of the fourth plurality of polygons for drawing in a pixel-by-pixel process on the display.

2. The method of claim 1 further comprising displaying each of the fourth plurality of polygons prepared for drawing in the pixel-by-pixel process on the display.

3. The method of claim 1 further comprising storing each of the fourth plurality of polygons prepared for drawing in the pixel-by-pixel process on the display.

4. The method of claim 1 further comprising transmitting over a network each of the fourth plurality of polygons prepared for drawing in the pixel-by-pixel process on the display.

5. The method of claim 4 further comprising displaying each of the fourth plurality of polygons prepared for drawing in the pixel-by-pixel process on the display.

6. The method of claim 1, wherein the pixel-by-pixel process comprises drawing a present pixel of one of the fourth plurality of polygons to a location on the display if the location is unoccupied or if the location is occupied by a previously drawn pixel that is further from the viewpoint than the present pixel.

7. The method of claim 1, wherein determining the second and third pluralities of polygons from the first plurality of polygons includes removing all of the polygons in the first plurality of polygons that are not visible in the scene.

8. The method of claim 1, wherein the dynamic graphics program is a Flash platform.

9. The method of claim 1, wherein the viewpoint represents a point in the scene from which a virtual camera views the scene.

10. The method of claim 1, wherein removing the portion of each of the third plurality of polygons determined to be not visible when viewed on the display comprises breaking each of the third plurality of polygons into at least two polygons.

11. A computer for rendering a 3D scene for viewing on a display using a dynamic graphics platform, the scene being represented by a first plurality of polygons in a 3D space, the computer comprising:
a controller configured to determine second and third pluralities of polygons from the first plurality of polygons, the second plurality of polygons determined to be substantially entirely visible in the scene at a viewpoint and the third plurality of polygons determined to be partially visible in the scene at the viewpoint;
the controller further configured to project vertices of the second and third pluralities of polygons for viewing onto the display;
the controller further configured to remove a portion of each of the third plurality of polygons determined to be not visible when viewed on the display to form a fourth plurality of polygons, the fourth plurality of polygons including the second plurality of polygons; and
the controller further configured to prepare each of the fourth plurality of polygons for drawing in a pixel-by-pixel process on the display.

12. The computer of claim 11, wherein the controller is further configured to display each of the fourth plurality of polygons prepared for drawing in the pixel-by-pixel process on the display.

13. The computer of claim 11, wherein the controller is further configured to store each of the fourth plurality of polygons prepared for drawing in the pixel-by-pixel process on the display.

14. The computer of claim 11, wherein the controller is further configured to transmit over a network each of the fourth plurality of polygons prepared for drawing in the pixel-by-pixel process on the display.

15. The computer of claim 14, wherein each of the fourth plurality of polygons prepared for drawing in the pixel-by-pixel process on the display is displayed.

16. The computer of claim 11, wherein the pixel-by-pixel process comprises drawing a present pixel of one of the fourth plurality of polygons to a location on the display if the location is unoccupied or if the location is occupied by a previously drawn pixel that is further from the viewpoint than the present pixel.

17. The computer of claim 11, wherein determining the second and third pluralities of polygons from the first plurality of polygons includes removing all of the polygons in the first plurality of polygons that are not visible in the scene.

18. The computer of claim 11, wherein the dynamic graphics platform is a Flash platform.

19. The computer of claim 11, wherein the viewpoint represents a point in the scene from which a virtual camera views the scene.

20. The computer of claim 11, wherein removing the portion of each of the third plurality of polygons determined to be not visible on the display comprises breaking each of the third plurality of polygons into at least two polygons.
